(19) United States
(12) Patent Application Publication
(10) Pub. No.: US 2026/0055961 A1
(43) Pub. Date: Feb. 26, 2026

(54) METHOD OF MANUFACTURING STRIP-SHAPED ELECTRODE PLATE AND MANUFACTURING APPARATUS FOR STRIP-SHAPED ELECTRODE PLATE

(71) Applicant: Prime Planet Energy & Solutions, Inc., Tokyo (JP)

(72) Inventor: Yusuke OKUHATA, Toyota-shi (JP)

(21) Appl. No.: 19/302,080

(22) Filed: Aug. 18, 2025

(30) Foreign Application Priority Data
Aug. 20, 2024 (JP) 2024-139166

(51) Int. Cl. F26B 3/28; F26B 13/14; H01M 4/75

(52) U.S. Cl. CPC F26B 3/283; F26B 13/14; H01M 4/75

(57) ABSTRACT

A method of manufacturing a strip-shaped electrode plate including a strip-shaped current collecting foil that extends in a longitudinal direction, an active material layer provided on a surface of the current collecting foil while leaving a foil exposed portion where the current collecting foil is exposed, and a protective layer provided between the foil exposed portion and the active material layer has a protective layer drying process of drying an undried protective layer that is provided on the current collecting foil and becomes the protective layer when dried. The protective layer drying process has a protective layer heating process of irradiating each protective layer irradiated area included in the undried protective layer with a linear p-polarized laser beam as linearly polarized light and p-polarized light at an incident angle of 20 degrees to 67 degrees to heat the protective layer irradiated area.

### CROSS-REFERENCE TO RELATED APPLICATIONS

This application is based upon and claims the benefit of priority to Japanese Patent Application No. 2024-139166 filed on Aug. 20, 2024, the entire contents of which are incorporated herein by reference.

### BACKGROUND

### Technical Field

The disclosure relates to a method of manufacturing a strip-shaped electrode plate having an active material layer and a protective layer on a strip-shaped current collecting foil, and an apparatus for manufacturing the strip-shaped electrode plate.

### Related Art

Japanese unexamined patent application publication No. 2021-174619 (JP 2021-174619 A) discloses a method of manufacturing a strip-shaped electrode plate having strip-shaped active material layers and strip-shaped protective layers on a strip-shaped current collecting foil. Specifically, a method of drying an undried active material layer and undried protective layers formed by coating on the current collecting foil, using hot air, is disclosed. Meanwhile, Japanese unexamined patent application publication No. 2023-169591 (JP 2023-169591 A) discloses a method of drying an undried active material layer formed by coating on a strip-shaped current collecting foil, using laser light, in the manufacture of a strip-shaped electrode plate having an active material layer on the current collecting foil.

### SUMMARY

### Technical Problems

In coating the current collecting foil with the undried active material layer and the undried protective layers, the solid content of paste for the protective layer is often required to be lower than that of active material paste in view of the ease of coating. Therefore, a larger amount of a dispersion medium per unit volume needs to be evaporated to dry the undried protective layer than to dry the undried active material layer. In addition, light-colored ceramic powder such as alumina powder is often used for the protective layer. Then, the protective layer is less likely to absorb infrared rays and is less likely to be heated. For these reasons, when hot air drying is performed as shown in JP 2021-174619A, it takes more time to dry the protective layer than to dry the active material layer.

Thus, according to the method disclosed in JP 2021-174619A, the flow velocity of the second hot air to dry the undried protective layer is set to be higher than that of the first hot air to dry the undried active material layer in order to accelerate drying of the protective layer. However, there is a limit to the acceleration of drying of the protective layer by means of hot air. Moreover, since this method uses a lot of hot air, the energy efficiency is low, and improvement has been sought.

On the other hand, in JP 2003-169591A, the undried active material layer is dried using laser light. However, when the undried protective layer is also dried with laser light in addition to the undried active material layer, it often takes more time to dry the protective layer than to dry the active material layer.

The disclosure was made in view of the above situation, and provides a method of manufacturing a strip-shaped electrode plate with which an undried protective layer can be heated efficiently, and a manufacturing apparatus for the strip-shaped electrode plate.

### Means of Solving the Problems

(1) One aspect of the disclosure for solving the above problem is a method of manufacturing a strip-shaped electrode plate including a current collecting foil that has a strip shape extending in a longitudinal direction, an active material layer provided on a surface of the current collecting foil while leaving a foil exposed portion where the current collecting foil is exposed, and a protective layer provided between the foil exposed portion and the active material layer. The method includes a protective layer drying process of drying an undried protective layer that is provided on the current collecting foil and becomes the protective layer when dried, and the protective layer drying process has a protective layer heating process of heating the protective layer by irradiating an irradiated area of the protective layer, the irradiated area being included in the undried protective layer with a linear p-polarized laser beam as linearly polarized light and p-polarized light at an incident angle of 20 degrees to 67 degrees to heat the irradiated area of the protective layer.

The undried protective layer is irradiated with the linear p-polarized laser beam with the incident angle controlled to the range of 20 degrees to 67 degrees. Then, it has been found that the absorption rate of the laser beam in the undried protective layer is higher than that of a linearly polarized and s-polarized laser beam applied to the undried protective layer, and is also higher than that of a linearly polarized or unpolarized (randomly polarized) laser beam vertically incident on the undried protective layer at an incident angle of 0 degrees. By utilizing this finding, the protective layer drying process of the manufacturing method described above includes the protective layer heating process of obliquely irradiating each irradiated area of the undried protective layer with the linear p-polarized laser beam at an incident angle of 20 degrees to 67 degrees to heat the irradiated area. Thus, with the manufacturing method described above, the undried protective layer can be efficiently heated in the protective layer heating process, which can contribute to the formation of the protective layer.

In the method of manufacturing the strip-shaped electrode plate described in (1) above, it is preferable that the active material layer is a strip-shaped active material layer that extends in the longitudinal direction, and the foil exposed portion is a strip-shaped foil exposed portion that extends in the longitudinal direction, while the protective layer is a strip-shaped protective layer that extends in the longitudinal direction. It is also preferable that the protective layer drying process is carried out while an undried strip-shaped electrode plate provided with the strip-shaped undried protective layer is being conveyed in a conveyance direction parallel to the longitudinal direction.
(2) In the method of manufacturing the strip-shaped electrode plate described in (1) above, the current collecting foil may be made of aluminum, and the protective layer heating process may include a process of irradiating at least an exposed portion irradiated area included in an adjacent exposed portion of the foil exposed portion that is located adjacent to the undried protective layer with the linear p-polarized laser beam at an incident angle of 25 degrees to 88 degrees to heat the exposed portion irradiated area. In this connection, when the current collecting foil is made of copper, the incident angle of the linear p-polarized laser beam may be controlled to within the range of 30 degrees to 86 degrees.
(3) In the method of manufacturing the strip-shaped electrode plate described in (1) or (2) above, the protective layer drying process may further have a protective layer hot air drying process of applying hot air to a hot air heated area including the irradiated area of the protective layer, which is included in the undried protective layer, to heat and dry the hot air heated area, in parallel with the protective layer heating process.
(4) In the method of manufacturing the strip-shaped electrode plate described in any one of (1) to (3) above, an undried strip-shaped electrode plate that becomes the strip-shaped electrode plate when dried may have an undried active material layer that becomes the active material layer when dried on the current collecting foil, in addition to the undried protective layer, and the protective layer drying process may include a process of drying the undried active material layer.
(5) In the method of manufacturing the strip-shaped electrode plate described in (4) above, the protective layer heating process may include a process of irradiating an active material layer irradiated area included in the undried active material layer with the linear p-polarized laser beam to heat the active material layer irradiated area.
(6) In the method of manufacturing the strip-shaped electrode plate described in (4) above, the protective layer drying process may have a laser heating process of irradiating the undried active material layer with a laser beam other than the linear p-polarized laser beam to heat the undried active material layer, in parallel with the protective layer heating process.
(7) Another aspect of the disclosure for solving the above problem is a manufacturing apparatus for a strip-shaped electrode plate including a strip-shaped current collecting foil that extends in a longitudinal direction, an active material layer provided on a surface of the current collecting foil while leaving a foil exposed portion where the current collecting foil is exposed, and a protective layer provided between the foil exposed portion and the active material layer. The manufacturing apparatus includes a conveying unit that conveys an undried strip-shaped electrode plate in which an undried protective layer that becomes the protective layer when dried is provided on the current collecting foil in a conveyance direction parallel to the longitudinal direction, and a protective layer drying unit that dries the undried protective layer. The protective layer drying unit has a protective layer heating unit that heats the undried protective layer by irradiating a protective layer irradiated area included in the undried protective layer with a linear p-polarized laser beam as linearly polarized light and p-polarized light at an incident angle of 20 degrees to 67 degrees. The protective layer drying unit of the manufacturing apparatus described above has the protective layer heating unit that heats the undried protective layer by obliquely irradiating each irradiated area with the linear p-polarized laser beam at an incident angle of 20 degrees to 67 degrees. Thus, in the manufacturing apparatus, the undried protective layer can be efficiently heated in the protective layer heating unit, which contributes to drying of the protective layer.
(8) In the manufacturing apparatus for the strip-shaped electrode plate described in (7) above, the current collecting foil may be made of aluminum, and the protective layer heating unit may irradiate at least each irradiated area included in an adjacent exposed portion of the foil exposed portion that is located adjacent to the undried protective layer with the linear p-polarized laser beam at an incident angle of 25 degrees to 88 degrees to heat the exposed portion irradiated area.
(9) In the manufacturing apparatus for the strip-shaped electrode plate described in (7) or (8) above, the protective layer drying unit may further have a protective layer hot air drying unit that applies hot air to a hot air heated area including the protective layer irradiated area of the undried protective layer to heat and dry the hot air heated area, in parallel with irradiation with the linear p-polarized laser beam in the protective layer heating unit.
(10) In the manufacturing apparatus for the strip-shaped electrode plate described in (9) above, the protective layer hot air drying unit may have a hot air sending unit that sends hot air and is placed on one side in the conveyance direction relative to the hot air heated area of the undried protective layer, and a hot air suction unit that sucks in the hot air sent from the hot air sending unit and used for heating the hot air heated area of the undried protective layer and is placed on the other side in the conveyance direction relative to the hot air heated area.
(11) In the manufacturing apparatus for the strip-shaped electrode plate described in any one of (7) to (10) above, the undried strip-shaped electrode plate may have an undried active material layer that becomes the active material layer when dried, on the current collecting foil, and the protective layer drying unit may dry the undried active material layer.
(12) In the manufacturing apparatus for the strip-shaped electrode plate described in (11) above, the protective layer heating unit may be configured to irradiate an active material layer irradiated area included in the undried active material layer with the linear p-polarized laser beam at an incident angle of 20 degrees to 67 degrees to heat the active material layer irradiated area.
(13) In the manufacturing apparatus for the strip-shaped electrode plate described in (11) above, the protective layer drying unit may have a laser heating unit that irradiates the undried active material layer with a laser beam other than the linear p-polarized laser beam to heat the undried active material layer, in parallel with heating of the undried protective layer by the protective layer heating unit.

### BRIEF DESCRIPTION OF THE DRAWINGS

FIG. 1 is an explanatory view of a strip-shaped electrode plate according to first to third embodiments and first to third modified examples;

FIG. 2 is a flowchart showing each step of the manufacture of the strip-shaped electrode plate according to the first to third embodiments and the first to third modified examples;

FIG. 3 is an explanatory view schematically showing the configuration of a manufacturing apparatus for the strip-shaped electrode plate according to the first and second embodiments and the first to third modified examples;

FIG. 4 is an explanatory cross-sectional view taken in the conveyance direction of a drying device according to the first embodiment and the first modified example;

FIG. 5 is an explanatory top view of the drying device according to the first embodiment and the first modified example;

FIG. 6 is an explanatory cross-sectional view taken in the conveyance direction of a drying device according to the second modified example;

FIG. 7 is an explanatory top view of the drying device according to the second modified example;

FIG. 8 is an explanatory cross-sectional view taken in the conveyance direction of a drying device according to the third modified example;

FIG. 9 is an explanatory top view of the drying device according to the third modified example;

FIG. 10 is an explanatory cross-sectional view taken in the width direction of a drying device according to the second embodiment;

FIG. 11 is an explanatory top view of the drying device according to the second embodiment;

FIG. 12 is an explanatory view schematically showing the configuration of a manufacturing apparatus for a strip-shaped electrode plate according to a third embodiment;

FIG. 13 is an explanatory cross-sectional view taken in the conveyance direction of a drying device according to the third embodiment;

FIG. 14 is an explanatory top view of the drying device according to the third embodiment;

FIG. 15 is a graph showing the relationship between the incident angle θi and the absorption rate obtained when p-polarized light and s-polarized light are applied to aluminum;

FIG. 16 is a graph showing the relationship between the incident angle θi and the absorption rate obtained when p-polarized light and s-polarized light are applied to copper; and

FIG. 17 is a graph showing the relationship between the incident angle θi and the absorption rate obtained when p-polarized light and s-polarized light are applied to alumina.

### DETAILED DESCRIPTION OF THE EXEMPLARY EMBODIMENTS

### First Embodiment

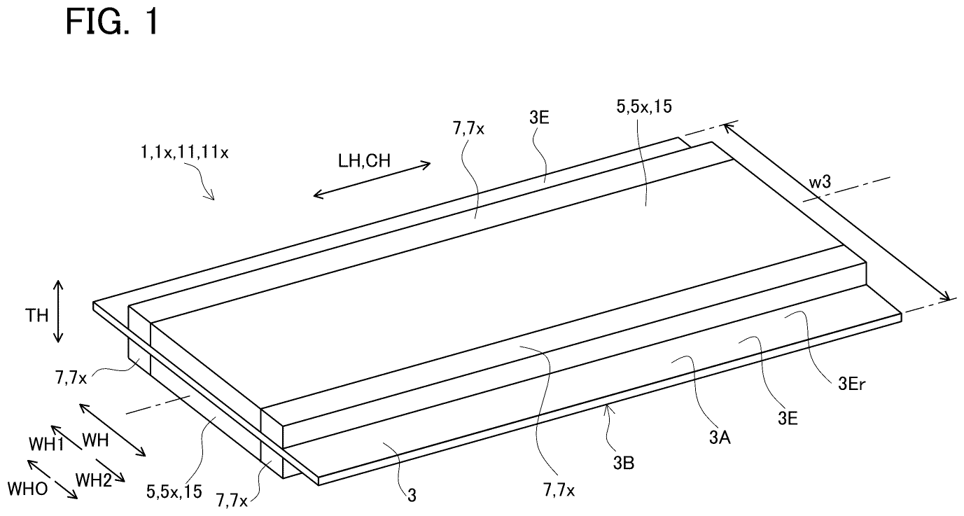

The manufacture of a strip-shaped electrode plate 1 in the form of a strip extending in the longitudinal direction LH and a manufacturing apparatus 100 for the strip-shaped electrode plate 1 according to a first embodiment of the disclosure will be described with reference to the drawings. The strip-shaped electrode plate 1 shown in FIG. 1 is used for an electrode body of a power storage device such as a secondary battery. The strip-shaped electrode plate 1 is used, for example, to manufacture rectangular and sealed lithium-ion secondary batteries, which will be installed on vehicles, such as HVs, PHEVs, and BEVs. Specifically, the strip-shaped electrode plate 1 is a strip-shaped positive electrode plate used to manufacture flat wound type or laminate type electrode bodies that constitute batteries.

The strip-shaped electrode plate 1 of the first embodiment includes a current collecting foil 3 that is made of aluminum and has a strip shape extending in the longitudinal direction LH, active material layers 5 provided on a first surface 3A and a second surface 3B of the current collecting foil 3 and shaped like strips extending in the longitudinal direction LH, and protective layers 7 similarly shaped like strips extending in the longitudinal direction LH. Of the current collecting foil 3, both edge portions in the width direction WH perpendicular to the longitudinal direction LH are strip-shaped foil exposed portions 3E where the current collecting foil 3 is exposed. The protective layers 7 are provided between the foil exposed portions 3E and the active material layers 5. The active material layer 5 contains lithium transition metal composite oxide particles as active material particles, acetylene black as conductive particles, and polyvinylidene fluoride (PVDF) as a binder. The protective layer 7 contains alumina particles, which are insulating ceramic particles, and PVDF as a binder.

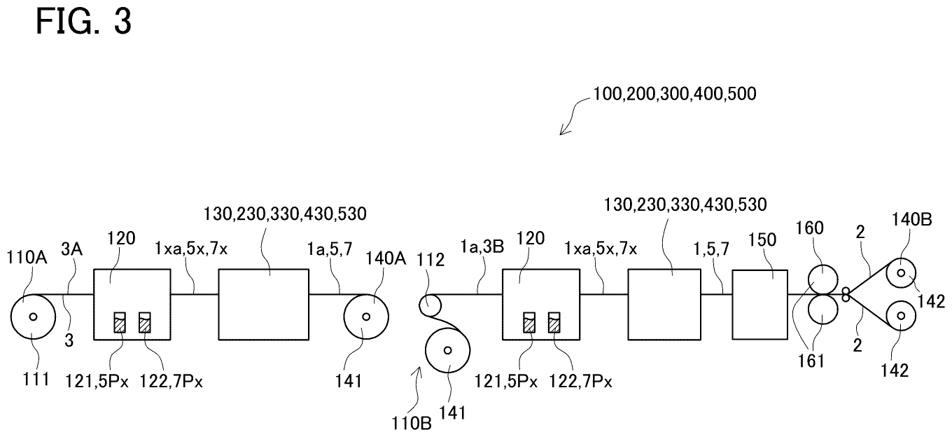

The active material layer 5 is formed by applying an active material paste 5Px to the current collecting foil 3 and then drying the active material paste 5Px (see FIG. 3). In the active material paste 5Px, the active material particles, conductive particles, and binder are dispersed in N-methylpyrrolidone (NMP) as a dispersion medium. In the first embodiment, the solid fraction of the active material paste 5Px is controlled to approximately 55 to 60 wt %.

On the other hand, the protective layer 7 is formed by applying a protective paste 7Px to the current collecting foil 3 and then drying the protective paste 7Px (see FIG. 3). In the protective paste 7Px, the insulating ceramic particles and the binder are dispersed in NMP as a dispersion medium. The solid fraction of the protective paste 7Px is approximately 25 to 30 wt %. That is, the proportion of the dispersion medium in the protective paste 7Px is higher than that in the active material paste 5Px, and the amount of the dispersion medium contained per unit volume in an undried protective layer 7x formed by applying the protective paste 7Px to the current collecting foil 3 is greater than that in an undried active material layer 5x formed by applying the active material paste 5Px to the current collecting foil 3.

Therefore, the undried protective layer 7x is less likely to dry than the undried active material layer 5x. Furthermore, the protective paste 7Px using alumina particles used in the first embodiment and the undried protective layer 7x as a coating of the protective paste 7Px are bright white and are less likely to absorb infrared rays. From this point of view, too, the undried protective layer 7x is less likely to be heated and less likely to be dried than the undried active material layer 5x. Accordingly, when the undried protective layer 7x is dried in parallel with the undried active material layer 5x using hot air or laser light, only the undried protective layer 7x is likely to be insufficiently dried.

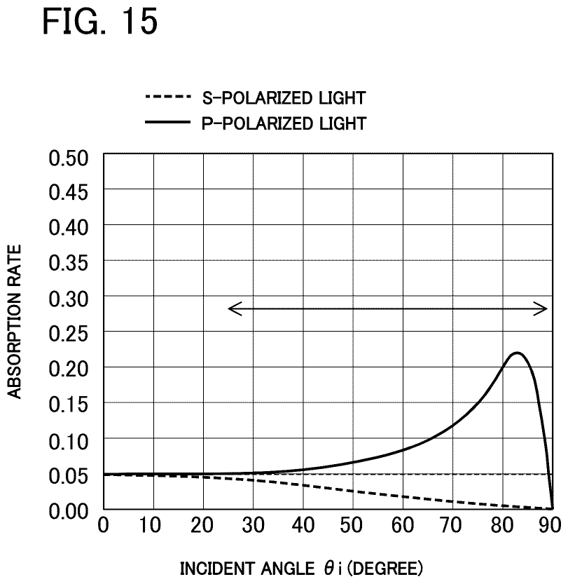

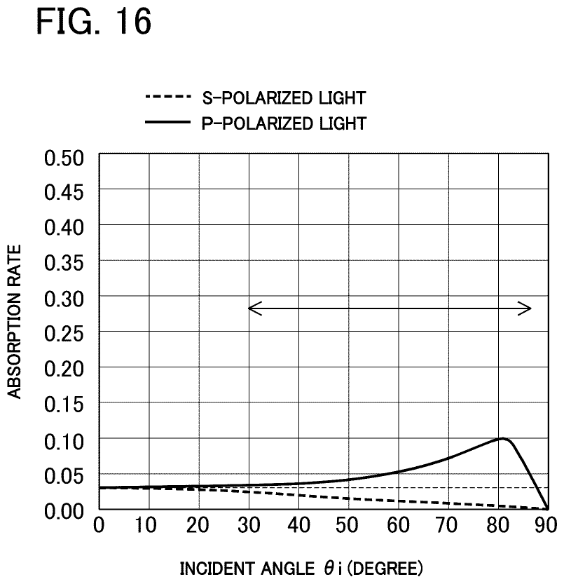

It is generally known that when a flat surface of a metal (e.g., aluminum, copper) is irradiated with a linearly polarized laser beam (wavelength λ=1064 nm), the change characteristics of the absorption rate with respect to the angle of incidence or incident angle θi (θi=0 to 90 degrees) are different between p-polarized light parallel to the incidence plane and s-polarized light perpendicular to the incidence plane. More specifically, when an s-polarized laser beam is incident on aluminum, the absorption rate is 5% for vertical incidence (incident angle θi=0 degrees), but it gradually decreases as the incident angle θi increases, and the absorption rate becomes zero at an incident angle θi of 90 degrees. On the other hand, when a p-polarized laser beam is incident on aluminum, the absorption rate is 5% for vertical incidence (incident angle θi=0 degrees), which is the same as that of the s-polarized one, but the absorption rate gradually increases as the incident angle θi increases, and reaches a maximum of 22% at an incident angle θi of about 84 degrees. Then, the absorption rate decreases rapidly as the incident angle increases, and becomes zero at an incident angle θi of 90 degrees (see FIG. 15). Thus, when the incident angle θi is in the range of approximately 25 to 88 degrees, the absorption rate of the p-polarized light is better than that for vertical incidence or oblique incidence of the s-polarized light. When s-polarized light or p-polarized light is incident on copper, too, the absorption rate generally shows similar characteristics though it is lower than that of aluminum (see FIG. 16). When the incident angle θi is in the range of approximately 30 to 86 degrees, the absorption rate of the p-polarized light is better than that for vertical incidence or oblique incidence of the s-polarized light. From these results, it is understood that when a laser beam of p-polarized light is obliquely applied to an irradiated area of aluminum or copper, the laser beam can be absorbed more efficiently compared to the case where a laser beam of s-polarized light or randomly polarized (unpolarized) light is used.

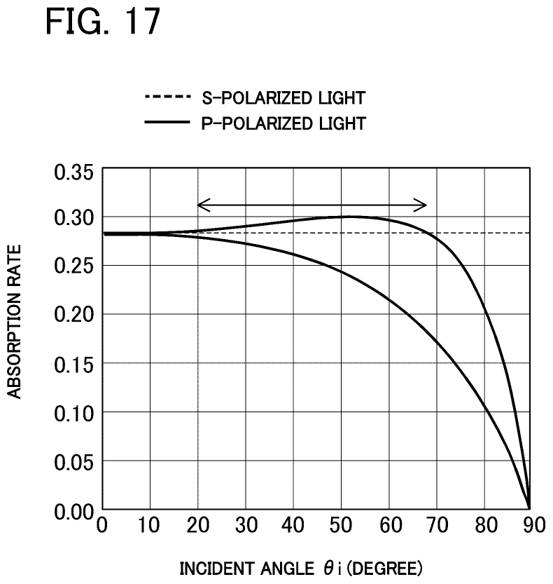

In addition, a p-polarized laser beam, when obliquely incident on a flat surface of alumina, is more likely to be absorbed compared to the case where an s-polarized laser beam or a randomly polarized (unpolarized) laser beam is used (see FIG. 17). Specifically, it is understood that when a flat surface of alumina is irradiated with a p-polarized laser beam that is incident thereon obliquely at an incident angle θi of 20 to 67 degrees, the laser beam can be more efficiently absorbed compared to the case where an s-polarized or randomly polarized (unpolarized) laser beam is obliquely incident on the surface. It was also found that when the undried protective layer 7x on which many ceramic particles such as alumina particles are deposited is irradiated with a laser beam, the absorption rate differs between p-polarized light and s-polarized light. Specifically, it was found that when the undried protective layer 7x is irradiated with a p-polarized laser beam that is incident thereon obliquely at an incident angle θi of 20 to 67 degrees, the laser beam is more likely to be absorbed and the undried protective layer 7x is more likely to be dried compared to the case where it is obliquely irradiated with an s-polarized or randomly polarized (unpolarized) laser beam. Although the incident angle of laser light varies among individual ceramic particles, the average angle of incidence on each ceramic particle is considered to depend on the incident angle θi with respect to the undried protective layer 7x.

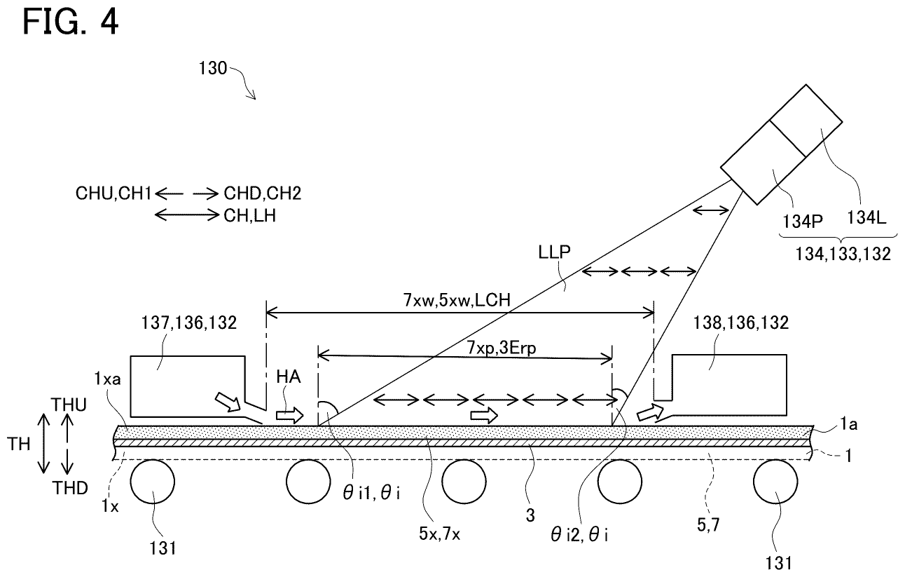

Thus, in the first embodiment, when the undried active material layer 5x and undried protective layers 7x formed on the current collecting foil 3 are dried with hot air, laser light is applied to at least irradiated areas 7xp of the undried protective layers 7x to accelerate drying thereof. Furthermore, the laser light applied to the irradiated areas 7xp is linearly polarized and p-polarized at each site of the irradiated area 7xp. In FIG. 4 and others, the polarization direction of laser light applied to the irradiated area 7xp, etc. is indicated by thick, two-way arrows.

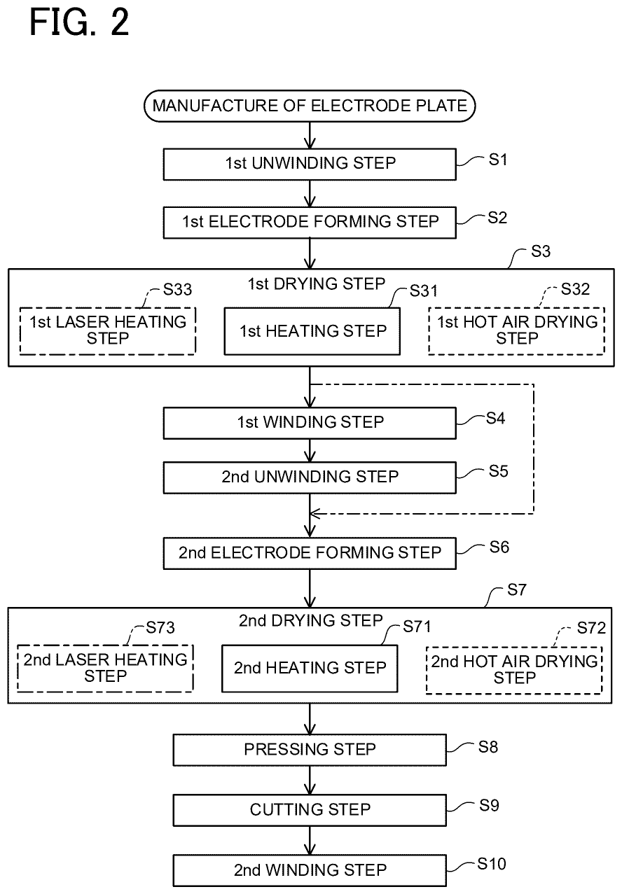

First, the method of manufacturing the strip-shaped electrode plate 1a, 1 using the manufacturing apparatus 100 will be schematically described with reference to FIG. 2 and FIG. 3. In a first unwinding step S1, the current collecting foil 3, which has been wound on a reel 111, is unwound by an unwinding device 110A and fed into a coating device 120.

In a first electrode forming step S2, in the coating device 120, the active material paste 5Px contained in a first tank 121 and the protective paste 7Px contained in a second tank 122 are used to form an undried strip-shaped electrode plate 1xa in which a strip-shaped undried active material layer 5x and strip-shaped undried protective layers 7x are provided on the first surface 3A of the current collecting foil 3. As described above, the undried active material layer 5x becomes the active material layer 5 after it is dried. The undried protective layer 7x becomes the protective layer 7 after it is dried.

In the first embodiment, the coating device 120 is specifically a die coater, which continuously discharges and applies the active material paste 5Px and the protective paste 7Px simultaneously toward the first surface 3A of the current collecting foil 3 conveyed in the longitudinal direction LH, to form the strip-shaped undried active material layer 5x and the undried insulating protective layers 7x along the undried active material layer 5x simultaneously. Foil exposed portions 3E where the current collecting foil 3 is exposed are left on the outer sides WHO in the width direction of the current collecting foil 3. As described above, the amount of the solvent (NMP) contained per unit volume in the undried insulating protective layer 7x is larger than that in the undried active material layer 5x.

Then, in a first drying step S3, the undried active material layer 5x and the undried insulating protective layers 7x of the undried strip-shaped electrode plate 1xa are dried using a drying device 130 that will be described in detail below, to form the strip-shaped electrode plate 1a having the active material layer 5 and the insulating protective layers 7 on the first surface 3A.

Then, in a first winding step S4, a winding device 140A is used to wind the strip-shaped electrode plate 1a once onto a reel 141. Then, in a second unwinding step S5, an unwinding device 110B is used to unwind the strip-shaped electrode plate 1a from the reel 141. Furthermore, the current collecting foil 3 is inverted with an inverting roll 112, and is fed to the coating device 120 as described above so that the second surface 3B becomes a coated surface that is to be coated with paste.

In a second electrode forming step S6, in the coating device 120, the active material paste 5Px and the protective paste 7Px are continuously applied to the second surface 3B of the current collecting foil 3 of the strip-shaped electrode plate 1a conveyed in the longitudinal direction LH, to form the undried strip-shaped electrode plate 1x provided with the strip-shaped undried active material layer 5x and the undried insulating protective layers 7x.

Then, in a second drying step S7, too, the drying device 130 that will be described in detail below is used to dry the undried active material layer 5x and the undried insulating protective layers 7x of the undried strip-shaped electrode plate 1x, so that the strip-shaped electrode plate 1 having the active material layer 5 and the insulating protective layers 7 on each of the first surface 3A and the second surface 3B is formed.

Then, in a pressing step S8, a press device 150 (specifically, a roll press) is used to roll-press the above-mentioned strip-shaped electrode plate 1 in the thickness direction TH while it is conveyed in the longitudinal direction LH, so as to increase the density of the active material layers 5 and the insulating protective layers 7. In this manner, the strip-shaped electrode plate 1 is completed.

Furthermore, in a cutting step S9, a cutting blade 161 is used to cut the strip-shaped electrode plate 1 (see FIG. 1) in half in the width direction WH to form divided electrode plates 2. In a subsequent second winding step S10, each of the divided electrode plates 2 is wound onto a reel 142 using a winding device 140B.

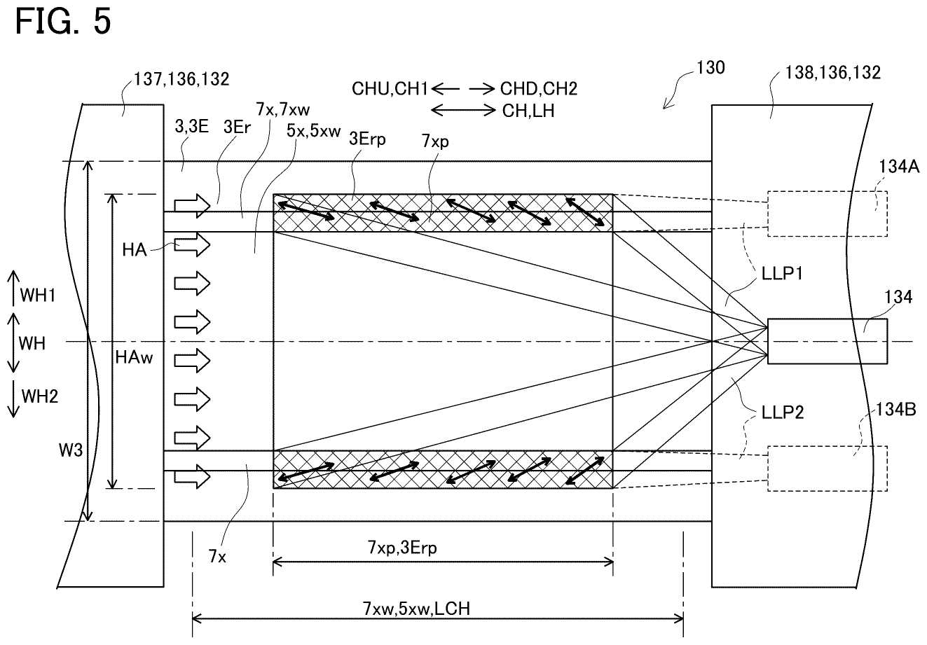

Next, the first drying step S3 and the second drying step S7, and the drying device 130 used in these steps will be described with reference to FIG. 2, FIG. 4, and FIG. 5. The second drying step S7 is almost the same as the first drying step S3; therefore, the first drying step S3 will be mainly described.

The first drying step S3 and the second drying step S7 are examples of the protective layer drying process of drying the undried protective layers 7x that become the protective layers 7. The first drying step S3 has a first heating step S31 (one example of the protective layer heating process), which is indicated by a solid line in FIG. 2, of obliquely applying linear p-polarized laser beams LLP1, LLP2 as linearly polarized and p-polarized light to irradiated areas 7xp included in the undried protective layers 7x provided on both sides in the width direction WH at an incident angle θi of 20 to 67 degrees to heat the irradiated areas 7xp. Similarly, the second drying step S7 has a second heating step S71 of applying linear p-polarized laser beams LLP1, LLP2 to the irradiated areas 7xp of the undried protective layers 7x to heat the irradiated areas 7xp. Thus, in the first heating step S31 and the second heating step S71, the undried protective layers 7x are efficiently heated and dried, which contributes to the formation of the protective layers 7.

Furthermore, the protective layers 7 and the undried protective layers 7x are shaped like strips extending in the longitudinal direction LH, and, in the first drying step S3 and the second drying step S7, the undried protective layers 7x are dried while the undried strip-shaped electrode plate 1xa, 1a provided with the undried protective layers 7x is being conveyed in the conveyance direction CH parallel to the longitudinal direction LH. Therefore, the linear p-polarized laser beams LLP1, LLP2 can be easily and continuously applied to the strip-shaped undried protective layers 7x conveyed in the conveyance direction CH, so that the undried protective layers 7x can be continuously heated.

In addition, the first drying step S3 of the first embodiment also has a first hot air drying step S32 as one example of the protective layer hot air drying process, which is indicated by a dashed line in FIG. 2, of drying the undried protective layers 7x by heating them with hot air HA, in parallel with the first heating step S31. Similarly, the second drying step S7 has a second hot air drying step S72 of drying the undried protective layers 7x by heating them with hot air HA. Thus, the first drying step S3 and the second drying step S7 also have the first hot air drying step S32 and the second hot air drying step S72, respectively, of drying hot air heated areas 7xw by heating them with hot air HA, in addition to heating of the irradiated areas 7xp of the undried protective layers 7x using the linear p-polarized laser beams LLP1, LLP2 in the first heating step S31 and the second heating step S71. Thus, the undried protective layers 7x can be dried more efficiently. Moreover, the use of hot air HA makes it possible to remove hot air HA containing a lot of evaporated dispersion medium (NMP in the first embodiment) from around the undried protective layers 7x, thus facilitating drying of the undried protective layers 7x.

Furthermore, as described above, in the first embodiment, the undried active material layer 5x that becomes the active material layer 5 when dried is provided, in addition to the undried protective layers 7x, on the current collecting foil 3. Accordingly, the first drying step S3 and the second drying step S7 are also steps of drying the undried active material layer 5x as well. In the first embodiment, specifically, in each of the first hot air drying step S32 and the second hot air drying step S72 of drying the undried protective layers 7x with hot air HA, the undried active material layer 5x is also heated and dried. Thus, the strip-shaped electrode plate 1a, 1 can be manufactured in a shorter process, compared to the case where the undried active material layers 5x are dried separately from the first drying step S3 and the second drying step S7.

In the first embodiment, the first drying step S3 having the first heating step S31 and the first hot air drying step S32 described above or the second drying step S7 having the second heating step S71 and the second hot air drying step S72 is performed using the drying device 130 shown in FIG. 4 and FIG. 5. The drying device 130 has a conveying unit 131 that conveys the undried strip-shaped electrode plate 1xa, 1x in which the undried protective layers 7x and the undried active material layer 5x are provided on the current collecting foil 3, in the conveyance direction CH (the lateral direction in FIG. 4 and FIG. 5) parallel to the longitudinal direction LH. In the first embodiment, the conveying unit 131 is specifically a number of conveying rollers. The drying device 130 further includes a drying unit 132 as one example of the protective layer drying unit that dries the undried protective layers 7x. In the first embodiment, the drying unit 132 also dries the undried active material layer 5x as described below.

The drying unit 132 has a heating unit 133 as one example of the protective layer heating unit that heats the undried protective layers 7x by irradiating the respective irradiated areas 7xp included in the undried protective layers 7x with the linear p-polarized laser beams LLP1, LLP2 that are obliquely incident thereon at an incident angle θi. The incident angle θi with respect to the undried protective layer 7x varies with each irradiated area 7xp, but is set to within the range of incident angle θi1 to θi2, which is the range of 20 to 67 degrees described above with reference to FIG. 17. Therefore, in the manufacturing method of the first embodiment, the undried protective layers 7x are efficiently heated through oblique incidence of the linear p-polarized laser beams LLP1, LLP2 in the first heating step S31 and the second heating step S71, which contributes to the formation of the protective layers 7. Also, with the drying device 130, the undried protective layers 7x can be efficiently heated through oblique incidence of the linear p-polarized laser beams LLP1, LLP2 in the above-mentioned range by the heating unit 133, which contributes to the formation of the protective layers 7.

In addition, the heating unit 133 of the first embodiment obliquely irradiates at least respective irradiated areas 3Erp included in adjacent exposed portions 3Er adjacent to the undried protective layers 7x, of the foil exposed portions 3E of the current collecting foil 3, with the linear p-polarized laser beams LLP1, LLP2 at an incident angle θi, to heat the irradiated areas 3Erp. The incident angle θi with respect to the adjacent exposed portion 3Er also varies with each irradiated area 3Erp, but is set to within the range of incident angle θi1 to θi2 that is the range of 25 to 88 degrees described above with reference to FIG. 15. Therefore, each irradiated area 3Erp of the adjacent exposed portions 3Er can also be efficiently heated through oblique incidence of the linear p-polarized laser beams LLP1, LLP2 in the above-mentioned range by the heating unit 133. It is thus possible to indirectly heat the undried protective layers 7x adjacent to the adjacent exposed portions 3Er and accelerate the drying of the protective layers 7. Also, through application of the linear p-polarized laser beams LLP1, LLP2 in the first heating step S31 and the second heating step S71, each irradiated area 3Erp of the adjacent exposed portions 3Er can also be efficiently heated, so that the undried protective layers 7x adjacent to the irradiated areas 3Erp can be indirectly heated to accelerate drying of the protective layers 7.

The linear p-polarized laser beams LLP1, LLP2 are generated by a linear p-polarized laser light source 134 that constitutes the heating unit 133. The linear p-polarized laser light source 134 consists of a laser light source 134L, which is a fiber laser that generates unpolarized laser light, and a polarization optical system 134P. The polarization optical system 134P converts the unpolarized laser light to linearly polarized laser light using multiple waveplates and DOEs. The polarization optical system 134P also splits the converted laser light into two beams: a linear p-polarized laser beam LLP1 that travels to one side WH1 (the left, upper side in FIG. 5) in the width direction WH at the upstream side CHU of the conveyance direction CH and is formed into a rectangular shape, and a linear p-polarized laser beam LLP2 that travels to the other side WH2 (the left, lower side in FIG. 5) in the width direction WH at the upstream side CHU of the conveyance direction CH and is formed into a rectangular shape. In the first embodiment, the linear p-polarized laser beams LLP1, LLP2 are radiated from the downstream side CHD to the upstream side CHU in the conveyance direction CH. Instead, the linear p-polarized laser beams LLP1, LLP2 may be radiated from the upstream side CHU to the downstream side CHD.

The drying unit 132 of the drying device 130 of the first embodiment also has a hot air drying unit 136 in addition to the heating unit 133. The hot air drying unit 136, which is one example of the protective layer hot air drying unit, applies hot air HA to the hot air heated areas 7xw including the irradiated areas 7xp of the undried protective layers 7x to heat and dry the hot air heated areas 7xw, in parallel with the application of the linear p-polarized laser beams LLP1, LLP2 using the heating unit 133. The hot air drying unit 136 of the first embodiment also dries a hot air heated area 5xw of the undried active material layer 5x as well as the hot air heated areas 7xw of the undried protective layers 7x.

The hot air drying unit 136 consists of a hot air sending unit 137 and a hot air suction unit 138. The hot air sending unit 137 is located at the upstream side CHU (the left-hand side in FIG. 4) of the hot air heated areas 7xw and the hot air heated area 5xw in the conveyance direction CH. As indicated by white arrows in FIG. 4 and FIG. 5, the hot air sending unit 137 sends, or blows, hot air HA toward the downstream side CHD (the right-hand side in FIG. 4 and FIG. 5) in the conveyance direction CH along the upper surfaces of the hot air heated areas 7xw and the hot air heated area 5xw, over the air blowing width Haw in the width direction WH. As a result, the hot air heated areas 7xw and the hot air heated area 5xw are heated and dried with hot air HA. On the other hand, the hot air suction unit 138 is located at the downstream side CHD of the hot air heated areas 7xw and the hot air heated area 5xw in the conveyance direction CH. The hot air suction unit 138 sucks in hot air HA that has finished heating the hot air heated areas 7xw and the hot air heated area 5xw over the conveyance direction distance LCH and contains vapor of the dispersion medium (NMP in the first embodiment), and discharges it to the outside.

Thus, in the drying device 130, the drying unit 132 has the hot air drying unit 136 that applies hot air HA to the hot air heated areas 7xw to heat and dry the areas 7xw, in parallel with heating of the irradiated areas 7xp through application of the linear p-polarized laser beams LLP1, LLP2 by the heating unit 133. Therefore, the undried protective layers 7x can be dried efficiently in a shorter time. Moreover, the hot air sending unit 137 is located at one side CH1 (the upstream side CHU in the first embodiment) of the upstream side CHU and the downstream side CHD of the hot air heated areas 7xw of the undried protective layers 7x in the conveyance direction CH, and the hot air suction unit 138 is located at the other side CH2 (the downstream side CHD in the first embodiment) in the conveyance direction CH. Therefore, regardless of the width dimension (the dimension in the width direction WH) W3 of the current collecting foil 3, the conveyance direction distance LCH of the hot air heated areas 7xw, 5xw exposed to and heated by hot air HA can be freely set; for example, the hot area heated areas of the undried protective layers 7x can be dried with hot air HA over the conveyance direction distance LCH that is longer than the width dimension W3.

Furthermore, in the drying device 130 of the manufacturing apparatus 100, the drying unit 132 dries the undried active material layer 5x in addition to the undried protective layers 7x. Thus, the strip-shaped electrode plate 1a, 1 can be manufactured in a shorter time, compared to the case where the undried active material layer 5x is not dried.

In the manufacturing method of the first embodiment as described above, the strip-shaped electrode plate 1a is once wound onto the reel 141 in the first winding step S4. Then, in the second unwinding step S5, the reel 141 on which the strip-shaped electrode plate 1a is wound is set in the unwinding device 110B, and the strip-shaped electrode plate 1a is unwound from the reel 141 and fed into the coating device 120. However, the first winding step S4 and the second unwinding step S5 may be skipped as indicated by a two-dot chain line in FIG. 2. That is, the strip-shaped electrode plate 1a obtained after the first drying step S3 may be reversed without being wound on the reel 141 and fed into the coating device 120, and the second electrode forming step S6 and subsequent steps may be performed.

In the manufacturing apparatus 100 of the first embodiment, a single drying device 130 shown in FIG. 4 and FIG. 5 is used to dry the undried protective layers 7x and the undried active material layer 5x of the undried strip-shaped electrode plate 1xa, 1x, to obtain the strip-shaped electrode plate 1a, 1 having the protective layers 7 and active material layer 5 that have been dried. However, when a long time or a long conveyance distance is required for drying of the undried protective layers 7x and the undried active material layer 5x, two or more drying devices 130 may be arranged in the conveyance direction CH and used for drying the undried protective layers 7x and the undried active material layer 5x. Alternatively, in the drying device 130, heating units 133 having linear p-polarized laser light sources 134 and hot air drying units 136 may be arranged in multiple stages in the conveyance direction CH.

In the first embodiment, only the irradiated areas 7xp and the irradiated areas 3Erp are heated with the linear p-polarized laser beams LLP1, LLP2. However, in order to dry the undried protective layers 7x more quickly, portions of the undried active material layer 5x adjacent to the irradiated areas 7xp, in addition to the irradiated areas 7xp and the irradiated areas 3Erp, may be heated with the linear p-polarized laser beams LLP1, LLP2.

### First Modified Example

Next, a first modified example of the first embodiment will be described. In the first embodiment, as indicated by solid lines in FIG. 5, a single linear p-polarized laser light source 134 that generates two linear p-polarized laser beams LLP1, LLP2 by splitting is used. In contrast, in the first modified example, two linear p-polarized laser light sources 134A, 134B that respectively generate a linear p-polarized laser beam LLP1 and a linear p-polarized laser beam LLP2 are used, as indicated by dotted lines in FIG. 5.

Although the drying device 130 of the first modified example requires the use of the two linear p-polarized laser light sources 134A, 134B, the output of each of the linear p-polarized laser light sources 134A, 134B is only about one half of that of the linear p-polarized laser light source 134, and there is no need to generate two linear p-polarized laser beams LLP1, LLP2 by splitting. Thus, the configuration of the polarization optical system used in the linear p-polarized laser light sources 134A, 134B can be simplified.

### Second Modified Example

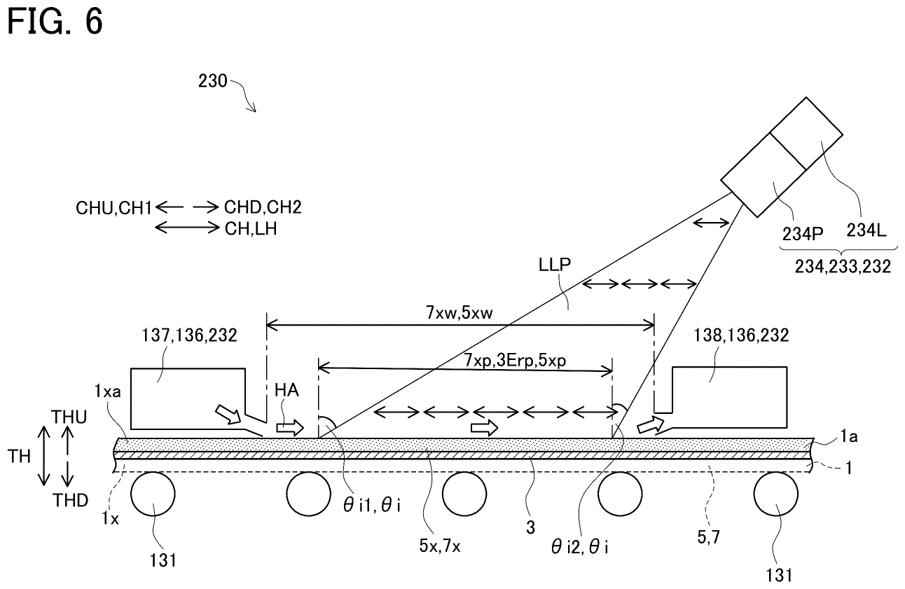

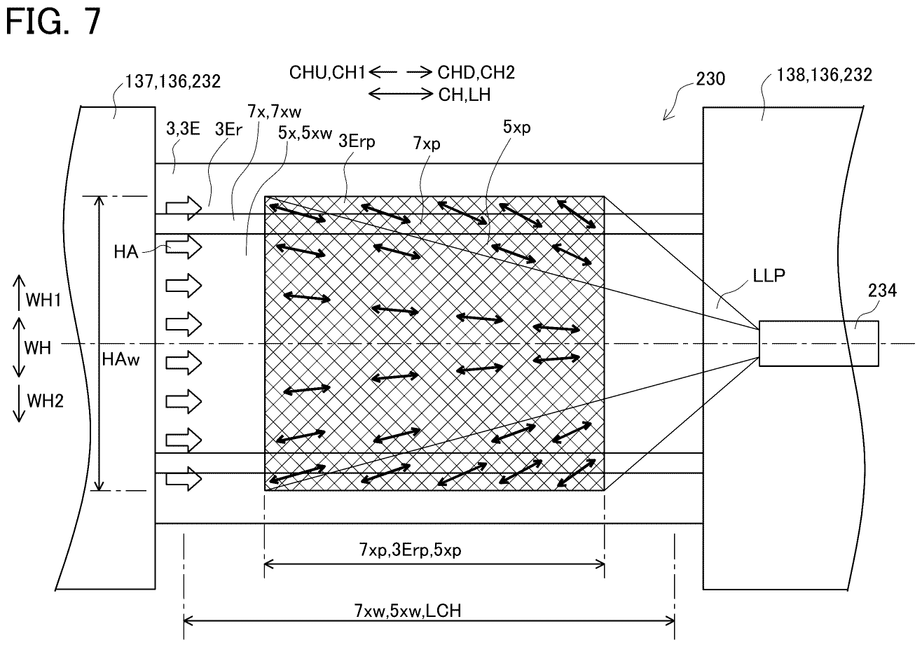

Next, a second modified example of the first embodiment will be described mainly with reference to FIG. 6 and FIG. 7. In the first embodiment, as indicated by solid lines in FIG. 5, two linear p-polarized laser beams LLP1, LLP2 generated by splitting from a single linear p-polarized laser light source 134 are applied to the irradiated areas 7xp of the undried protective layers 7x and the irradiated areas 3Erp of the adjacent exposed portions 3Er of the current collecting foil 3 to heat the irradiated areas.

In contrast, in the first drying step S3 and the second drying step S7 of the second modified example and in a drying device 230 of a manufacturing apparatus 200 that carries out these steps S3, S7, a linear p-polarized laser light source 234 that generates a linear p-polarized laser beam LLP, shown in FIG. 7, is used as a heating unit 233 of a drying unit 232. Like the linear p-polarized laser light source 134 of the first embodiment, the linear p-polarized laser light source 234 applies the linear p-polarized laser beam LLP to the irradiated areas 7xp of the undried protective layers 7x and the irradiated areas 3Erp of the adjacent exposed portions 3Er of the current collecting foil 3 to heat these irradiated areas. In addition, the linear p-polarized laser light source 234 obliquely irradiates an irradiated area 5xp of the undried active material layer 5x with the linear p-polarized laser beam LLP to heat the irradiated area 5xp, too.

That is, in the drying device 230 used in the first heating step S31 and the second heating step S71, the irradiated area 5xp of the undried active material layer 5x is also heated with the linear p-polarized laser beam LLP incident thereon obliquely. Thus, the undried active material layer 5x as well as the undried protective layers 7x can be dried efficiently.

The intensity per unit area of the linear p-polarized laser beam LLP applied to the irradiated areas 7xp, the irradiated areas 3Erp, and the irradiated area 5xp may be made uniform. However, it is preferable that the irradiation intensity for the irradiated areas 7xp and the irradiated areas 3Erp is set to be higher than that for the irradiated area 5xp, so that the irradiated areas 7xp, 3Erps are more heated.

In the second modified example, the irradiated area 5xp of the undried active material layer 5x, in addition to the irradiated areas 7xp and the irradiated areas 3Erp, is heated with the linear p-polarized laser beam LLP generated by the single linear p-polarized laser light source 234. However, as in the first embodiment, the irradiated areas 7xp and the irradiated areas 3Erp may be heated with the linear p-polarized laser beams LLP1, LLP2 generated by the linear p-polarized laser light source 134, and additionally another linear p-polarized laser light source (not shown) may be used to heat the irradiated area 5xp of the undried active material layer 5x. Furthermore, in order to appropriately heat the irradiated area 5xp of the undried active material layer 5x that is wider than the irradiated area 7xp, etc., the irradiated area 5xp may be divided into two or more sections, and two or more linear p-polarized laser light sources may be used as other linear p-polarized laser light sources, to heat the sections of the irradiated area 5xp with the respective linear p-polarized laser light sources.

### Third Modified Example

In the heating unit 233 of the drying unit 232 of the second modified example described above, the linear p-polarized laser beam LLP is also applied from the linear p-polarized laser light source 234 to the irradiated area 5xp of the undried active material layer 5x to heat the irradiated area 5xp (see FIG. 7).

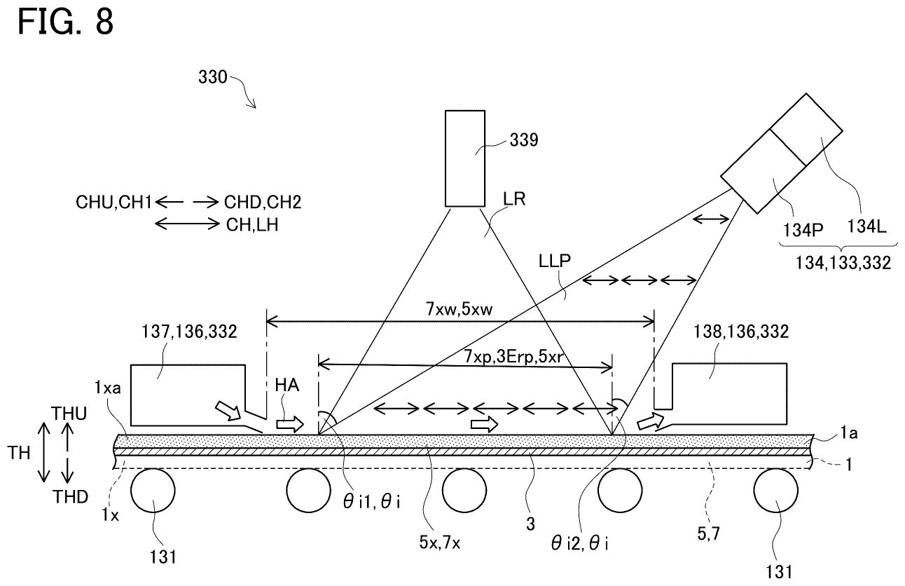

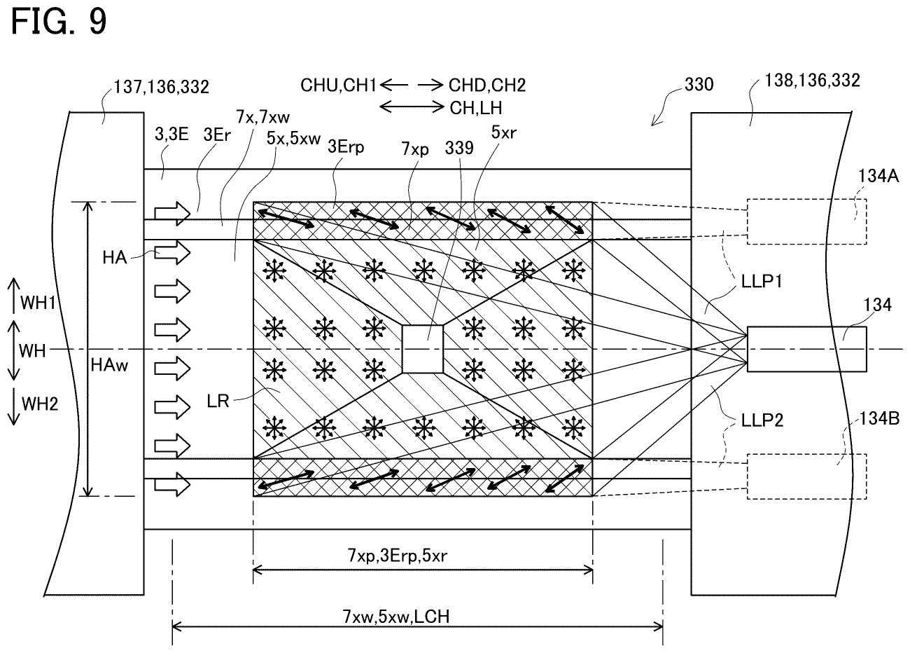

In contrast, in a drying unit 332 shown in FIG. 8 and FIG. 9, of a drying device 330 of a third modified example, the same linear p-polarized laser light source 134 as that of the heating unit 133 of the first embodiment is used to generate two linear p-polarized laser beams LLP1, LLP2, which are applied to the irradiated areas 7xp of the undried protective layers 7x and the irradiated areas 3Erp of the adjacent exposed portions 3Er of the current collecting foil 3 to heat the irradiated areas. In addition, the drying unit 332 of the third modified example has a laser heating unit 339 that generates another unpolarized laser beam LR different from the linear p-polarized laser beams LLP1, LLP2, and the laser heating unit 339 applies the unpolarized laser beam LR to each rectangular irradiated area 5xr of the undried active material layer 5x to heat and dry the irradiated area 5xr. Thus, the drying device 330 can efficiently dry the undried active material layer 5x as well as the undried protective layers 7x. In FIG. 9, the unpolarized laser beam LR applied to the irradiated area 5xr is indicated by symbols each consisting of four two-way arrows that intersect at an angle of 45 degrees.

In the manufacturing method of the third modified example, the first drying step S3 has a first laser heating step S33 indicated by a one-dot chain line in FIG. 2 of applying the unpolarized laser beam LR different from the linear p-polarized laser beams LLP1, LLP2 to the irradiated area 5xr of the undried active material layer 5x to heat the irradiated area 5xr, in parallel with the first heating step S31 and the first hot air drying step S32. The second drying step S7 also has a second laser heating step S73 indicated by a one-dot chain line of applying the unpolarized laser beam LR to the irradiated area 5xr to heat the irradiated area 5xr, in parallel with the second heating step S71 and the second hot air drying step S72. Thus, according to this manufacturing method, the undried active material layer 5x as well as the undried protective layers 7x can be dried efficiently.

### Second Embodiment

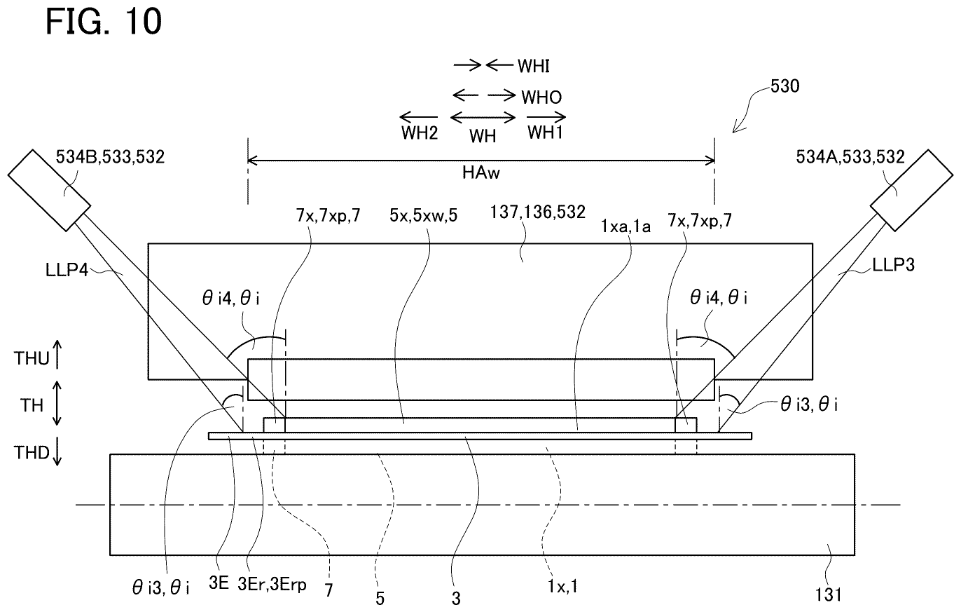

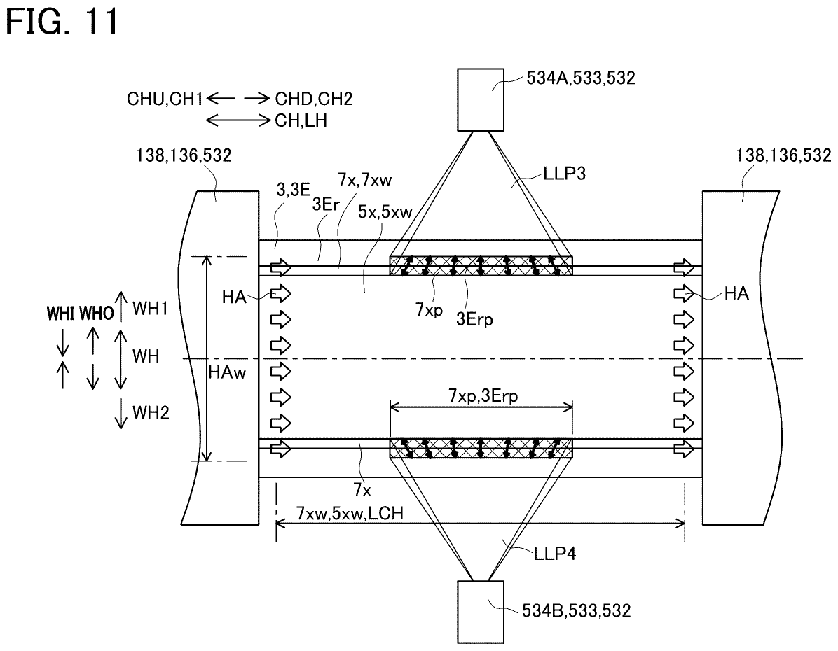

Next, a manufacturing apparatus 500 according to a second embodiment will be described mainly with reference to FIG. 10 and FIG. 11. In the drying devices 130 to 330 of the manufacturing apparatuses 100 to 300 of the first embodiment and the first to third modified examples described above, the linear p-polarized laser light source 134, 134A, 134B, 234 is located at the downstream side CHD (the right-hand side in FIG. 3 to FIG. 8) of the irradiated areas 7xp of the undried protective layers 7x in the conveyance direction CH, and emits the linear p-polarized laser beams LLP1, LLP2, LLP toward the upstream side CHU in the conveyance direction CH and toward the lower side THD (downward in FIG. 3, FIG. 5, FIG. 7) in the thickness direction TH of the current collecting foil 3.

In contrast, in a drying device 530 of the manufacturing apparatus 500 of the second embodiment, a linear p-polarized laser light source 534A as a heating unit 533 of a drying unit 532 is located on one side WH1 (the right-hand side in FIG. 10, the upper side in FIG. 11) relative to the undried active material layer 5x and the undried protective layers 7x in the width direction WH. In addition, a linear p-polarized laser light source 534B is located on the other side WH2 (the left-hand side in FIG. 10, the lower side in FIG. 11) relative to the undried active material layer 5x and the undried protective layers 7x in the width direction WH.

The two linear p-polarized laser light sources 534A, 534B emit linear p-polarized laser beams LLP3, LLP4, respectively, toward the inner side WHI in the width direction WH and toward the lower side THD (obliquely downward in FIG. 10) in the thickness direction TH of the current collecting foil 3. As a result, the irradiated areas 7xp of the undried protective layers 7x and the irradiated areas 3Erp of the adjacent exposed portions 3Er of the current collecting foil 3 are irradiated with the linear p-polarized laser beams LLP3, LLP4 at an incident angle θi controlled to the range of θi3 to θi4 within the range of 20 to 67 degrees, so that these irradiated areas are heated.

In the drying device 530 of the second embodiment, too, the hot air heated areas 7xw of the undried protective layers 7x and the hot air heated area 5xw of the undried active material layer 5x are heated and dried with hot air HA blown from the hot air sending unit 137 to the downstream side CHD in the conveyance direction CH, as in the drying device 130, etc. of the first embodiment, etc.

In the drying device 530 of the second embodiment, as described above, the two linear p-polarized laser light sources 534A, 534B are used to irradiate the irradiated areas 7xp of the undried protective layers 7x and the irradiated areas 3Erp of the adjacent exposed portions 3Er of the current collecting foil 3 extending in the longitudinal direction LH (the conveyance direction CH) with the linear p-polarized laser beams LLP3, LLP4 applied from the outer side WHO of the current collecting foil 3 in the width direction WH, and heat the irradiated areas 7xp, 3Erp. Therefore, it is easier to uniformly irradiate the respective irradiated areas 7xp and irradiated areas 3Erp with the linear p-polarized laser beams LLP3, LL4, compared to the drying device 130, etc. of the first embodiment, etc. that radiates the linear p-polarized laser beams LLP1, LLP2 from the downstream side CHD in the conveyance direction CH.

Steps S1 to S10 of the manufacturing method for the strip-shaped electrode plate 1 of the second embodiment are substantially the same as those of the first embodiment (see FIG. 2).

In the drying device 530 of the second embodiment, the undried protective layer 7x on one side WH1 in the width direction WH, as one of the two undried protective layers 7xp extending in the longitudinal direction LH (the conveyance direction CH), is irradiated with the linear p-polarized laser beam LLP3 emitted from the linear p-polarized laser light source 534A located on one side WH1 relative to the undried protective layer 7x. In addition, the undried protective layer 7x on the other side WH2 is irradiated with the linear p-polarized laser beam LLP4 emitted from the linear p-polarized laser light source 534B located on the other side WH2 relative to the undried protective layer 7x. However, the two linear p-polarized laser beams LLP3, LLP4 may be applied to the undried protective layers 7x while crossing each other so as to make the incident angle θi larger. That is, the linear p-polarized laser beam LLP4 may be applied from the linear p-polarized laser light source 534B located on the other side WH2 to the undried protective layer 7x on one side WH1, and the linear p-polarized laser beam LLP3 may be applied from the linear p-polarized laser light source 534A located on one side WH1 to the undried protective layer 7x on the other side WH2.

### Third Embodiment

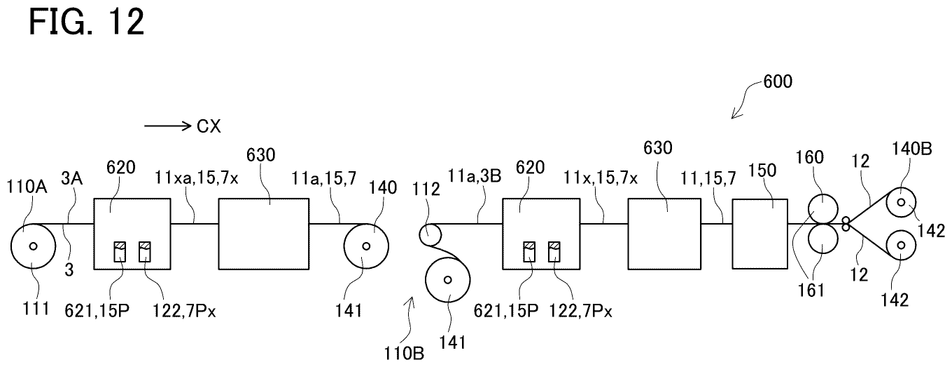

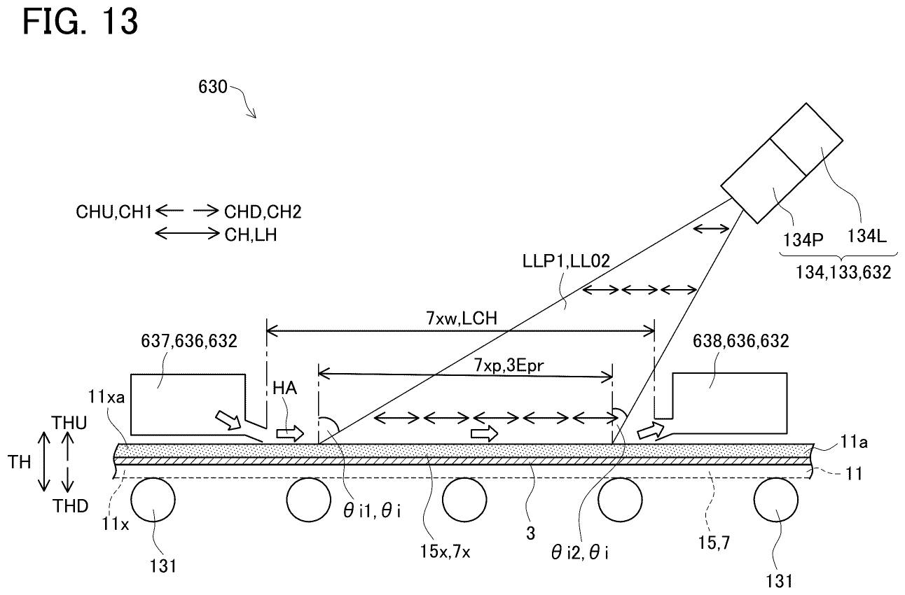

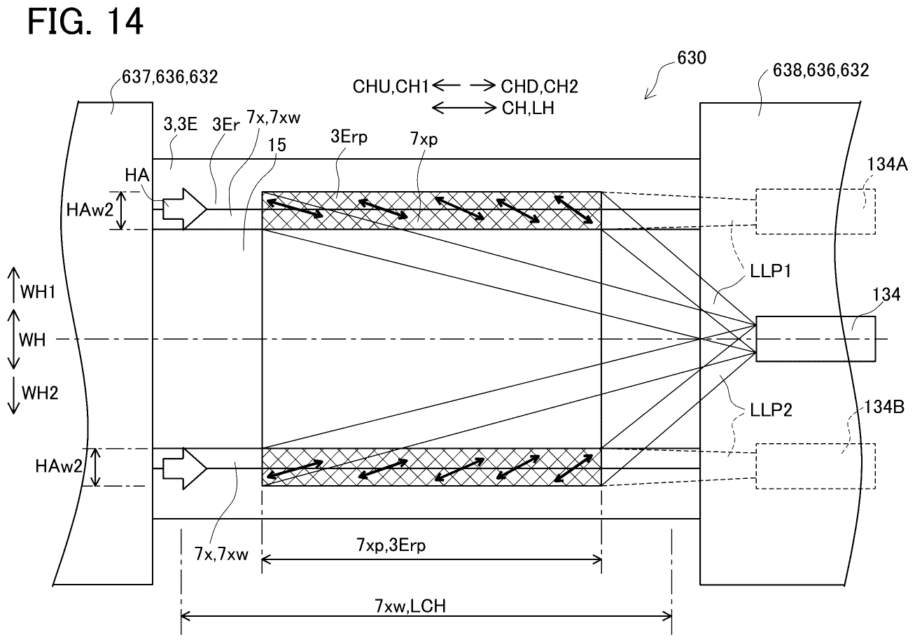

Next, a method of manufacturing a strip-shaped electrode plate 11a, 11 and a manufacturing apparatus 600 according to a third embodiment will be described mainly with reference to FIG. 12 to FIG. 14. In the above-described first embodiment, etc., in the manufacture of the strip-shaped electrode plate 1a, 1, the protective layer 7 is formed by drying the undried protective layer 7x formed by applying the protective paste 7Px to the current collecting foil 3, and the active material layer 5 is formed by drying the undried active material layer 5x formed by applying the active material paste 5Px to the current collecting foil 3.

In the third embodiment, too, the protective layer 7 is formed by drying the undried protective layer 7x formed by applying the protective paste 7Px to the current collecting foil 3, as in the first embodiment, etc. However, the third embodiment is different from the first embodiment, etc. in that the active material layer 15 is completed using an active material 15P that need not be dried on the current collecting foil 3. With this difference, the third embodiment is different from the first embodiment, etc. in the first electrode forming step S2, the first drying step S3, the second electrode forming step S6, and the second drying step S7, out of steps S1 to S10 of the method of manufacturing the strip-shaped electrode plate 11a, 11 and divided electrode plates 12 (see FIG. 2 and FIG. 12).

Specifically, in the manufacture of the strip-shaped electrode plate 11a, 11, in the first electrode forming step S2 and the second electrode forming step S6, the strip-shaped active material layer 15 is formed on the first surface 3A of the current collecting foil 3 using the active material 15P stored in a first tank 621 in a coating device 620. In addition, the strip-shaped undried protective layers 7x are formed adjacent to the active material layer 15 on the first surface 3A of the current collecting foil 3, using the protective paste 7Px stored in the second tank 122.

The active material 15P is, for example, a mixed powder of active material particles, conductive particles, and resin particles, such as PTFE, that can be partially fibrillated. In one example of the method of forming the active material layer 15 on the surface 3A, 3B of the current collecting foil 3, using the active material 15P in the form of the mixed powder, the above-mentioned mixed powder is mixed together so that the resin materials are partially fibrillated to construct a network that connects the active material particles, and then the mixed powder is rolled into a sheet to form the self-standing active material layer 15. The active material layer 15 is then bonded to the current collecting foil 3.

Furthermore, the undried protective layers 7x in the form of strips are formed by applying the protective paste 7Px by die coating, for example, between the strip-shaped active material layer 15 formed on the surface 3A, 3B of the current collecting foil 3 and the foil exposed portions 3E of the current collecting foil 3. Thus, the undried strip-shaped electrode plate 1xa having two strip-shaped undried protective layers 7x is formed (see FIG. 1).

Then, in the first drying step S3 and the second drying step S7, only the undried insulating protective layers 7x are dried using a drying device 630 that will be described in detail below, and the strip-shaped electrode plate 11a having the active material layer 5 and the insulating protective layers 7 on the first surface 3A, or the strip-shaped electrode plate 11 having the active material layers 5 and the insulating protective layers 7 on both of the surfaces 3A, 3B is formed.

Next, the drying device 630 of the manufacturing apparatus 600 of the third embodiment will be described. In the drying device 130 (see FIG. 4, FIG. 5) of the first embodiment, the hot air sending unit 137 and the hot air suction unit 138 that constitute the hot air drying unit 136 are used to dry not only the hot air heated areas 7xw of the undried protective layers 7x but also the hot air heated area 5xw of the undried active material layer 5x. For this purpose, the hot air sending unit 137 is caused to blow hot air HA in the form of a strip or a band expanding in the width direction WH, as indicated by white arrows in FIG. 5.

In contrast, in the third embodiment, a hot air sending unit 637 of a hot air drying unit 636 is configured to blow out two streams of hot air HA that hit the hot air heated areas 7xw including the irradiated areas 7xp of the two strip-shaped undried protective layers 7x formed on the undried strip-shaped electrode plate 1xa, 1x that is conveyed, unlike the drying device 130 of the first embodiment. It is thus possible to efficiently dry the undried protective layers 7x without letting hot air HA hit the active material layer 15 that need not be dried. In the drying device 630 of the third embodiment, portions of the adjacent exposed portions 3Er of the foil exposed portions 3E of the current collecting foil 3 that are located adjacent to the hot air heated areas 7xw, in addition to the hot air heated areas 7xw, are heated with two streams of hot air HA, so that heating of the hot air heated areas 7xw is accelerated.

In the third embodiment, the active material layer 15 that need not be dried is formed on the current collecting foil 3. However, the drying device 630 described above may also be used to form the undried protective layers 7x by coating with the protective paste 7Px after the active material paste 5Px is applied to the current collecting foil 3 and dried in advance to form the active material layer 5.

The disclosure has been described in terms of the first to third embodiments and the first to third modified examples. However, the disclosure is not limited to the embodiments, etc., but may be changed as needed and applied without departing from the principle thereof.

For example, as the strip-shaped electrode plate 1 formed in the first embodiment, etc., an example is shown in which the strip-shaped active material layers 5, 15 extending in the longitudinal direction LH are formed on the strip-shaped current collecting foil 3 (see FIG. 1). However, a strip-shaped electrode plate may be formed in which a large number of mutually independent, island-shaped active material layers each having a planar shape such as a rectangular shape and arranged intermittently in the longitudinal direction LH are provided on the strip-shaped current collecting foil 3. In the strip-shaped electrode plate having the independent active material layers, as described above, independent protective layers each having a linear shape such as a straight line, L-shape, U-shape, frame-like shape, etc., may be provided at necessary sites between the independent active material layers and the foil exposed portions around them.

In the first embodiment and others, the current collecting foil 3 made of aluminum is used. However, the disclosure may be applied to the case where a strip-shaped electrode plate is manufactured using a current collecting foil made of copper.

### REFERENCE SIGNS LIST

CH Conveyance direction
CH1 One side (of conveyance direction)
CH2 Other side (of conveyance direction)
LH Longitudinal direction
WH Width direction
WH1 One side (of width direction)
WH2 Other side (of width direction)
1, 1a, 11, 11a Strip-shaped electrode plate
1x, 1xa, 11x, 11xa Undried strip-shaped electrode plate
3 Current collecting foil
3A First surface (surface) (of current collecting foil)
3B Second surface (surface) (of current collecting foil)
3E Foil exposed portion
3Er Adjacent exposed portion
3Erp Irradiated area (exposed portion irradiated area)
5, 15 Active material layer
5x Undried active material layer
5xp Irradiated area (active material layer irradiated area)
5xr Irradiated area (active material layer irradiated area)
5xw Hot air heated area
7 Protective layer
7x Undried protective layer
7xp Irradiated area (protective layer irradiated area)
7xw Hot air heated area
100, 200, 300, 500, 600 Manufacturing apparatus
130, 230, 330, 530, 630 Drying device
131 Conveying unit
132, 232, 332, 532, 632 Drying unit (protective layer drying unit)
133, 233, 533 Heating unit (protective layer heating unit)
134, 134A, 134B, 234, 534A, 534B Linear p-polarized laser light source
LLP1, LLP2, LLP, LLP3, LLP4 Linear p-polarized laser beam
θi, θi1, θi2, θi3, θi4 Incident angle (of linear p-polarized laser beam)
134L, 234L Laser light source
134P, 234P Polarization optical system
136, 636 Hot air drying unit (protective layer hot air drying unit)
137, 637 Hot air sending unit
138, 638 Hot air suction unit
HA Hot air
339 Laser heating unit
LR Unpolarized laser beam (another laser beam)
S2 First electrode forming step
S3 First drying step (protective layer drying step)
S31 First heating step (protective layer heating step)
S32 First hot air drying step (protective layer hot air drying step)
S33 First laser heating step (laser heating step)
S6 Second electrode forming step
S7 Second drying step (protective layer drying step)
S71 Second heating step (protective layer heating step)
S72 Second hot air drying step (protective layer hot air drying step)
S73 Second laser heating step (laser heating step)

What is claimed is:

1. A method of manufacturing a strip-shaped electrode plate including a current collecting foil that has a strip shape extending in a longitudinal direction, an active material layer provided on a surface of the current collecting foil while leaving a foil exposed portion where the current collecting foil is exposed, and a protective layer provided between the foil exposed portion and the active material layer, the method comprising:
drying an undried protective layer that is provided on the current collecting foil and becomes the protective layer when dried,
wherein drying the undried protective layer has heating the protective layer by irradiating an irradiated area of the protective layer, the irradiated area being included in the undried protective layer, with a linear p-polarized laser beam as linearly polarized light and p-polarized light at an incident angle of 20 degrees to 67 degrees to heat the irradiated area of the protective layer.

2. The method of manufacturing the strip-shaped electrode plate according to claim 1, wherein:
the current collecting foil is made of aluminum; and
heating the protective layer includes irradiating at least an exposed portion irradiated area included in an adjacent exposed portion of the foil exposed portion that is located adjacent to the undried protective layer with the linear p-polarized laser beam at an incident angle of 25 degrees to 88 degrees to heat the exposed portion irradiated area.

3. The method manufacturing the strip-shaped electrode plate according to claim 1, wherein drying the undried protective layer further has applying hot air to a hot air heated area including the irradiated area of the protective layer, which is included in the undried protective layer, to heat and dry the hot air heated area, in parallel with heating the protective layer.

4. The method manufacturing the strip-shaped electrode plate according to claim 2, wherein drying the undried protective layer further has applying hot air to a hot air heated area including the irradiated area of the protective layer, which is included in the undried protective layer, to heat and dry the hot air heated area, in parallel with heating the protective layer.

5. The method manufacturing the strip-shaped electrode plate according to claim 1, wherein:
an undried strip-shaped electrode plate that becomes the strip-shaped electrode plate when dried has an undried active material layer that becomes the active material layer when dried on the current collecting foil, in addition to the undried protective layer; and
drying the undried protective layer includes drying the undried active material layer.

6. The method manufacturing the strip-shaped electrode plate according to claim 2, wherein:
an undried strip-shaped electrode plate that becomes the strip-shaped electrode plate when dried has an undried active material layer that becomes the active material layer when dried on the current collecting foil, in addition to the undried protective layer; and
drying the undried protective layer includes drying the undried active material layer.

7. The method manufacturing the strip-shaped electrode plate according to claim 5, wherein heating the protective layer includes irradiating an active material layer irradiated area included in the undried active material layer with the linear p-polarized laser beam to heat the active material layer irradiated area.

8. The method manufacturing the strip-shaped electrode plate according to claim 6, wherein heating the protective layer includes irradiating an active material layer irradiated area included in the undried active material layer with the linear p-polarized laser beam to heat the active material layer irradiated area.

9. The method manufacturing the strip-shaped electrode plate according to claim 5, wherein drying the undried protective layer has irradiating the undried active material layer with a laser beam other than the linear p-polarized laser beam to heat the undried active material layer, in parallel with heating the protective layer.

10. The method manufacturing the strip-shaped electrode plate according to claim 6, wherein drying the undried protective layer has irradiating the undried active material layer with a laser beam other than the linear p-polarized laser beam to heat the undried active material layer, in parallel with heating the protective layer.

11. A manufacturing apparatus for a strip-shaped electrode plate including a strip-shaped current collecting foil that extends in a longitudinal direction, an active material layer provided on a surface of the current collecting foil while leaving a foil exposed portion where the current collecting foil is exposed, and a protective layer provided between the foil exposed portion and the active material layer, the manufacturing apparatus comprising:
a conveying unit that conveys an undried strip-shaped electrode plate in which an undried protective layer that becomes the protective layer when dried is provided on the current collecting foil in a conveyance direction parallel to the longitudinal direction; and
a protective layer drying unit that dries the undried protective layer,
wherein the protective layer drying unit has a protective layer heating unit that heats the undried protective layer by irradiating a protective layer irradiated area included in the undried protective layer with a linear p-polarized laser beam as linearly polarized light and p-polarized light at an incident angle of 20 degrees to 67 degrees.

12. The manufacturing apparatus for the strip-shaped electrode plate according to claim 11, wherein:
the current collecting foil is made of aluminum; and
the protective layer heating unit irradiates at least an exposed portion irradiated area included in an adjacent exposed portion of the foil exposed portion that is located adjacent to the undried protective layer with the linear p-polarized laser beam at an incident angle of 25 degrees to 88 degrees to heat the exposed portion irradiated area.

13. The manufacturing apparatus for the strip-shaped electrode plate according to claim 11, wherein the protective layer drying unit further has a protective layer hot air drying unit that applies hot air to a hot air heated area including the protective layer irradiated area of the undried protective layer to heat and dry the hot air heated area, in parallel with irradiation with the linear p-polarized laser beam in the protective layer heating unit.

14. The manufacturing apparatus for the strip-shaped electrode plate according to claim 12, wherein the protective layer hot air drying unit has a hot air sending unit that sends hot air and is placed on one side in the conveyance direction relative to the hot air heated area of the undried protective layer, and a hot air suction unit that sucks in the hot air sent from the hot air sending unit and used for heating the hot air heated area of the undried protective layer and is placed on the other side in the conveyance direction relative to the hot air heated area.

15. The manufacturing apparatus according to claim 13, wherein the protective layer hot air drying unit has a hot air sending unit that sends hot air and is placed on one side in the conveyance direction relative to the hot air heated area of the undried protective layer, and a hot air suction unit that sucks in the hot air sent from the hot air sending unit and used for heating the hot air heated area of the undried protective layer and is placed on the other side in the conveyance direction relative to the hot air heated area.

16. The manufacturing apparatus according to claim 14, wherein the protective layer hot air drying unit has a hot air sending unit that sends hot air and is placed on one side in the conveyance direction relative to the hot air heated area of the undried protective layer, and a hot air suction unit that sucks in the hot air sent from the hot air sending unit and used for heating the hot air heated area of the undried protective layer and is placed on the other side in the conveyance direction relative to the hot air heated area.

17. The manufacturing apparatus according to claim 11, wherein:
the undried strip-shaped electrode plate has an undried active material layer that becomes the active material layer when dried, on the current collecting foil; and
the protective layer drying unit dries the undried active material layer.

18. The manufacturing apparatus according to claim 12, wherein:
the undried strip-shaped electrode plate has an undried active material layer that becomes the active material layer when dried, on the current collecting foil; and
the protective layer drying unit dries the undried active material layer.

19. The manufacturing apparatus according to claim 17, wherein the protective layer heating unit is configured to irradiate an active material layer irradiated area included in the undried active material layer with the linear p-polarized laser beam at an incident angle of 20 degrees to 67 degrees to heat the active material layer irradiated area.

20. The manufacturing apparatus according to claim 17, wherein the protective layer drying unit has a laser heating unit that irradiates the undried active material layer with a laser beam other than the linear p-polarized laser beam to heat the undried active material layer, in parallel with heating of the undried protective layer by the protective layer heating unit.
